(19) United States
(12) Patent Application Publication
(10) Pub. No.: US 2006/0156008 A1
(43) Pub. Date: Jul. 13, 2006

(54) Last line of defense ensuring and enforcing sufficiently valid/current code

(75) Inventor: Alexander Frank, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/034,377

(22) Filed: Jan. 12, 2005

(51) Int. Cl. H04L 9/00

(52) U.S. Cl. 713/176; 713/181

(57) ABSTRACT

A computer is adapted for self-validation using a dedicated validation circuit or process. The validation circuit may include a timing circuit for activating the validation process, a verification circuit for verifying the computer is in compliance with a pre-determined set of conditions and an enforcement circuit for imposing a sanction on the computer when the computer is found in a non-compliant state. The validation circuit may include cryptographic circuitry or processes for hashing and digital signature verification. The validation circuit is preferable small and portable to help ensure that the validation circuit itself is not vulnerable to a widespread attack. A self-validation method for use by a computer is also disclosed.

### TECHNICAL FIELD

This patent relates generally to computers, and in particular to a computer adapted for protection from tampering of software, firmware and microcode.

### BACKGROUND

Computer systems are increasingly complex. As the complexity increases, so do the opportunities to introduce vulnerabilities to individual components of the computer. This is true in the case of not only general software, but especially firmware and microcode associated with both the boot process and the operation of the microprocessor. Exhaustive testing of such complex system building blocks is no longer possible. Complex software (including firmware or microcode) may have unintended uses or side effects even when carefully designed, coded and tested. Thus, security gaps may exist in even the computers that originally met all design requirements and passed rigorous testing procedures. Such security gaps may only come to light after widespread release of the product and concerted efforts to uncover any hidden vulnerabilities.

This characteristic of modern computers may have widespread effects. Not only may the security of the individual computer be compromised, but networks and other computers coupled to the networks may also be compromised. Once a computer is compromised, new software, firmware or microcode may be loaded and executed, further compromising the individual system and related systems. The effects on agencies and enterprises can be widespread.

One business model that is particularly vulnerable to attack is a pay-per-use plan where computers are given away or sold at a subsidized price by an underwriter, such as a service provider, where the underwriter expects future revenue to pay back the subsidy. When controls put in place to ensure compliance with contractual terms of use are compromised, the underwriter may face significant losses.

### SUMMARY

As discussed above, the complexity of the computer and the advances in technology may make 100% effective measures nearly impossible for at least two reasons. First, as mentioned above, no system can be guaranteed to be free of characteristics that allow compromising the system, whether an outright defect, or a previously undiscovered side effect. Secondly, as technology advances, current security measures may become obsolete allowing previously secure systems to be easily compromised. For example, in the recent past, the DES algorithm using 48-bit keys was considered secure. Now, however, advances in computer power and the ability to link computers has made such security measures virtually worthless. As disclosed herein, it may be desirable to place into a computer a “last line of defense” validation circuit for the ultimate protection of the computer. Ideally, the validation circuit may be small, portable, and extremely well tested, to ensure that the validation circuit itself does not introduce new vulnerabilities. Further, the validation circuit may be embedded sufficiently deep into a computer so that to defeat the validation circuit requires a hardware attack that is more costly to mount than the value of the computer. Such a validation circuit may be built into the processor itself, or another major semiconductor component. Code for the validation routines may be embedded with the processor microcode. Ideally, the last line of defense code and state are separate from the rest of the microcode or firmware. This modularity improves overall security because defeating the security of any other part of the processor or its microcode/firmware still doesn't compromise the last line of defense.

Activation of the validation circuit may occur at long intervals, perhaps even several months, but the sanctions available when the validation circuit determines the computer may have been “hijacked” may be severe. The sanctions may require that the computer be returned to a support location or connect to the original service provider for restoration to an operational state. The sanctions may include deactivation of the computer, severe slowing of the processor, reducing the instruction set architecture (ISA) available for program execution, or other measures. The simpler the sanction is, the easier is to ensure its security strength. Given that sanctioning should be a rare event, the severity of the sanction is not an issue. On the contrary, the more severe the better to ensure that users will not simply ignore the sanction or unwittingly use a tampered computer or computer component, including software. The more severe a well publicized sanction is, the lower the risk of widespread attempts to compromise the originally-designed system. The process for validating the computer may include, but is not limited to, requiring presentation of digitally signed software, hashing a memory range or evaluating an expiration date. For example, a user with a subsidized pay-per-use computer may be tempted to use a program found on the Internet to change the way usage is metered. However, when it is learned that the computer may suddenly stop working and require a service call, the user may think a second time about attempting the fraud. In another example, when a vulnerability is found that may be propagated over the Internet, widespread fraud may occur. However, if the validation circuit is hosted on a portion of the processor or a major interface chip, only those users with relatively sophisticated equipment are likely to attempt a hardware attack on the silicon itself.

### BRIEF DESCRIPTION OF THE DRAWINGS

FIG. 1 is a simplified and representative block diagram of a computer network;

FIG. 2 is a block diagram of a computer that may be connected to the network of FIG. 1;

FIG. 3 is a block diagram of an exemplary computer similar to that of FIG. 2, showing details of the validation circuit;

FIG. 4 is block diagram of an exemplary processor incorporating a validation circuit; and

FIG. 5 is a flowchart showing a method for validating the authenticity and/or integrity of computer software, firmware or microcode.

### DETAILED DESCRIPTION OF VARIOUS EMBODIMENTS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

Many prior art high-value computers, personal digital assistants, organizers and the like may not be suitable for use in a pre-pay or pay-for-use business model without additional security measures. The addition of a small, well tested and difficult-to-tamper validation circuit may both reduce attempts to alter a computer as well as provide service providers of pay-per-use computers, enterprise information technology managers, Internet service providers and others with a last line of defense against other system attacks.

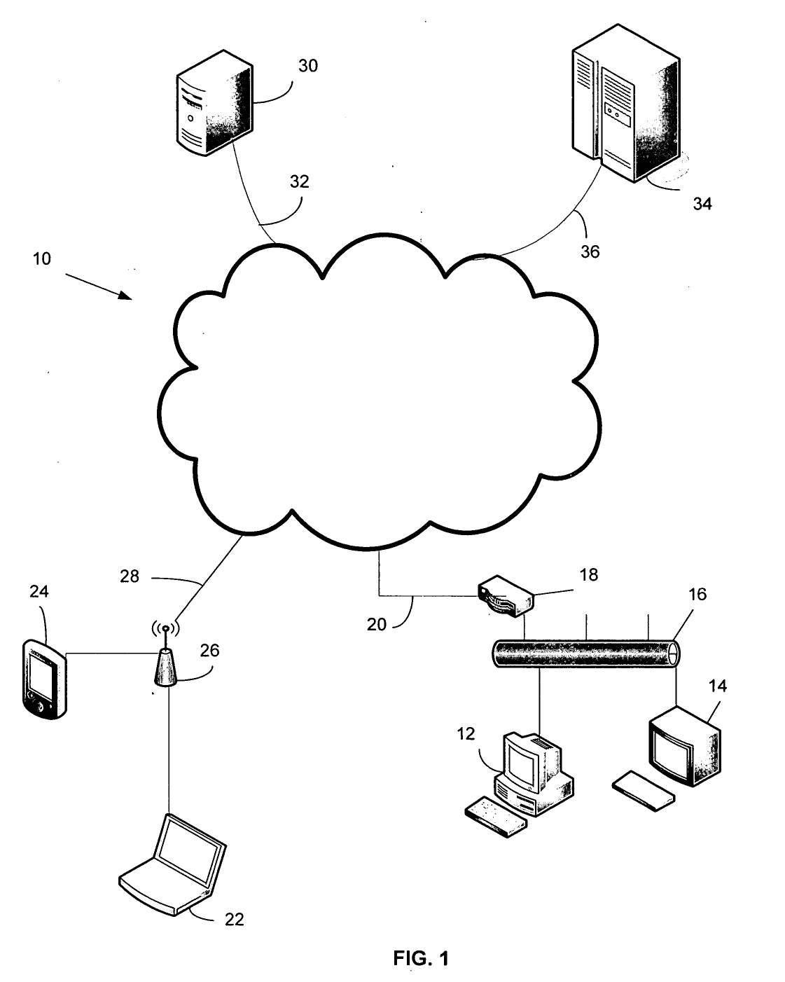

FIG. 1 illustrates a network 10 that may be used to implement a dynamic software provisioning system. The network 10 may be the Internet, a virtual private network (VPN), or any other network that allows one or more computers, communication devices, databases, etc., to be communicatively connected to each other. The network 10 may be connected to a personal computer 12 and a computer terminal 14 via an Ethernet 16 and a router 18, and a landline 20. On the other hand, the network 10 may wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. As it will be described below in further detail, one or more components of the dynamic software provisioning system may be stored and operated on any of the various devices connected to the network 10.

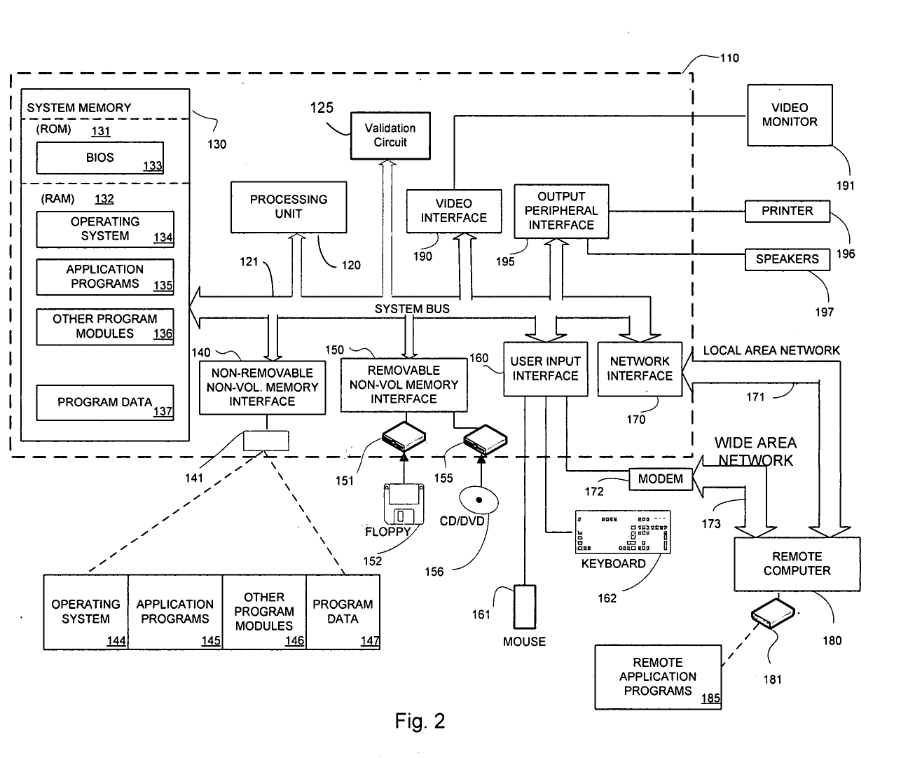

FIG. 2 illustrates a computing device in the form of a computer 110 that may be connected to the network 10 and used to implement one or more components of the dynamic software provisioning system. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

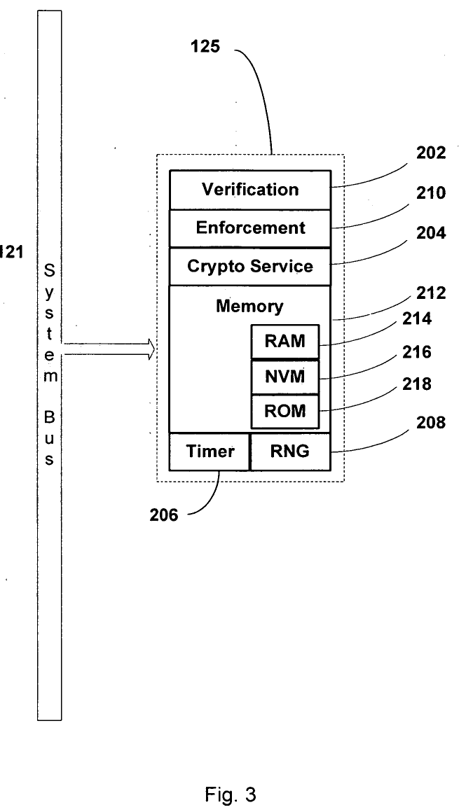

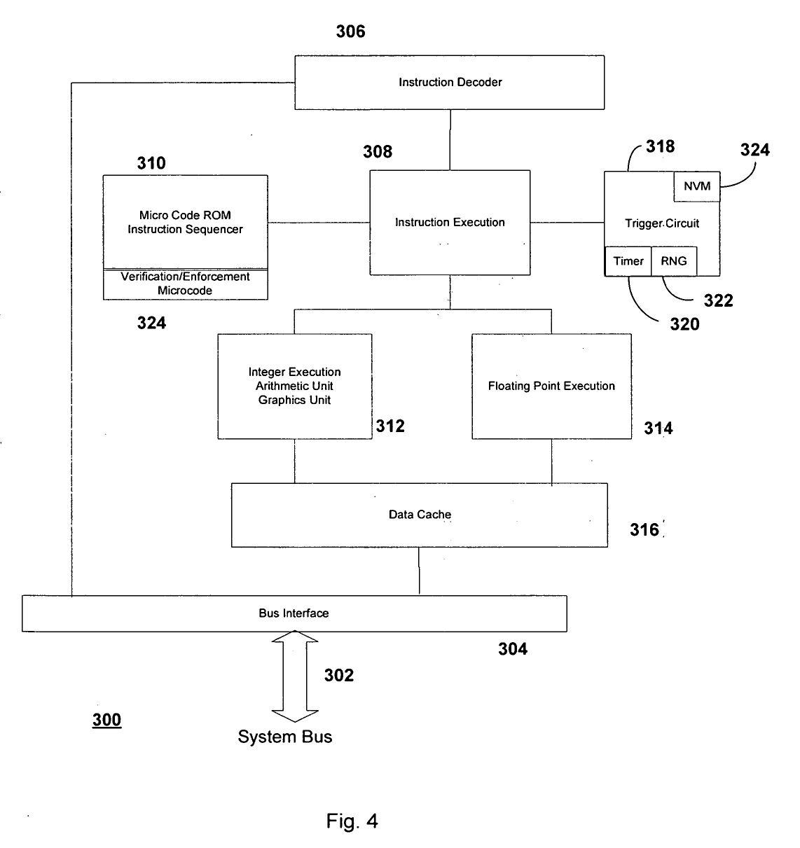

The computer 110 may also include a validation circuit 125 for periodically monitoring a state of the computer 110 and for enforcing related policies when such non-compliant states are determined. The validation circuit 125 is discussed in more detail below with respect to FIG. 3 and FIG. 4.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

FIG. 3 shows a validation circuit 125 suitable for verifying the validity of software, firmware or microcode on computer 110. As opposed to a monitor or hypervisor, the validation circuit 125 serves as a final backup against security vulnerabilities in the rest of the computer 110. Code or circuitry associated with the validation circuit 125 may be small enough to be well tested and ideally has been subjected to public scrutiny and testing, similar to public cryptographic algorithms. The validation circuit 125 may be the last available defense against a determined attacker and may be especially useful in defense of a pay-per-use or pay-as-you go computer distribution/business model.

The validation circuit 125 may have several standard elements, including a verification function 202, a cryptographic service 204, a clock or timer 206, a random number generator 208 and an enforcement function 210. The validation circuit 125 may also include a memory 212. The memory 212 may have random access memory (RAM) 214, non-volatile memory (NVM) 216, used for storing persistent information such as keys, certificates, other secrets and flags. The memory may also have read-only memory (ROM) 218. ROM in general is highly tamper resistant and therefore the ROM 218 may be an ideal place to store executable routines associated with the validation circuit 125. In addition, never-changing keys, for example, root certificate authority or a public key, may be stored in ROM 218. The verification and enforcement functions 202 210 may be hardware, firmware or software associated with the tasks of verification of a valid operating state and enforcement of a sanction should the computer 110 be found in a non-compliant state. The cryptographic service 204 may include a hash engine, such as a SHA-1 hash algorithm, and may also include an encryption algorithm, such as an RSA™ asymmetric public key algorithm. The cryptographic service 204 should be able to execute/support the validation test, i.e. authenticity and integrity verification of the subject code to be protected. This may be done utilizing public-key cryptography, cryptographic hashing, a digital-signature scheme or a combination of these techniques. The timer may be a simple counting circuit or may be an implementation of a full real-time clock.

The random number generator 208 may be used to supply statistically sufficient random numbers for supplying a nonce or challenge to a third party. The RNG 208 may also be used for creating a non-predictable event to trigger a verification of the computer 110. That is, a number or collection of numbers may be pre-selected from the range of possible random numbers generated by the RNG 208. The RNG 208 may be programmed to generate a random at a given interval. When the number generated matches the number or collection of numbers, the match may trigger the verification operation. When the rate of number generation, the maximum range of the RNG 208 and the number of values in the collection of numbers is known, it is a straightforward calculation to determine the mean time between matching events. For example, matching 100 numbers from a pool of 100,000,000 at one number per second will result in a mean test frequency of about 11.57 days using the formula:
Mean match time=(RNG range)/(# in collection*frequency)

In an exemplary embodiment, the validation circuit 125 may be separate from any software monitor or trusted platform module (TPM) associated with the day-to-day operation of the computer 110. The application of a trusted platform module is described in U.S. patent application “System and Method to Lock TPM Always ‘On’ Using a Monitor” attorney reference no. 30835/40478, which is hereby incorporated by reference. A trusted platform module may be an integrated circuit that is used to establish a trusted environment during boot and for initiating programs. The TPM may be operated in conjunction with a monitor or hypervisor to form the basis of a trusted environment. The implementation of a trusted environment using a TPM and a monitor/hypervisor can be relatively large from a code perspective. It may not be possible to exhaustively test such components for all possible security holes and therefore the components relied upon for security, may in fact introduce vulnerabilities. Moreover, software elements, such as the monitor, may be subject to attacks that are easily propagated over the Internet, causing widespread damage to the business underwriter. Lastly, the building blocks of the trusted environment, such as the TPM and monitor, may not be effective at checking their own integrity and may not be able to thwart attacks that modify the monitor or other elements of the trusted environment, especially after initial operation. To reduce the long term vulnerability to attack through the compromise of the operating system or security building blocks, the validation circuit 125 may be designed to check the integrity of the other system security building blocks. The validation circuit 125 itself, especially its software components, may be small enough to be more easily tested to assure integrity. In one embodiment, significant elements of the validation circuit 125, for example, the cryptographic service 204 may be implemented in hardware or use a separate processor and microcode (not depicted) to further protect itself from attack. The validation circuit 125 may be designed and implemented in a manner that checks the integrity of the components above itself well after the boot process is finished and normal operation is underway, as opposed to the TPM/monitor.

Furthermore, it may be desirable to have the logic/code and state isolated from the rest of the system. For instance, assuming a CPU micro-code is being protected by the validation circuit 125, it is desirable that the CPU micro-code will have no means to access the logic/code and state of the validation circuit 125. Yet another measure to be considered is having the logic/code of the validation circuit 125 hard coded, e.g. in ROM, such that overwriting it isn't an option.

When correctly designed and implemented, the validation circuit may be reusable across various devices and platforms. That is, as long as it is programmed with an expected measurement and associated criteria, for example, a memory range, the validation circuit 125 may be employed in applications ranging from personal computers and personal digital assistants to cellular telephones, embedded systems, firmware based computers, micro-code based CPUs, etc. The assumption may be made that by the time the validation circuit 125 finds a non-compliant measurement in the computer 110, that the computer 110 has been breached and all other lines of defense have been compromised. Therefore, the sanctions taken by the validation circuit 125 may be severe and therefore not necessarily platform or operating system specific.

One embodiment of the validation circuit 125 may involve placing the validation circuit 125 on the same chip with a processor, as shown in FIG. 4. In a highly simplified block diagram, FIG. 4 depicts some of the major elements of a processor 300, such as might be found in the processing unit 120 of FIG. 2. Interface to the processor may be through a system bus 302 and bus interface 304. Instructions may be evaluated in the instruction decoder 306. Instructions may be executed and cached in the instruction execution block 308. Program or firmware instructions for the processor or processor/computer micro-code may be stored in micro-code ROM 310. Data may be further manipulated in integer execution unit 312 and floating point unit 314. Results may be stored and sequenced for placing on the system bus 302 in the data cache 316. When implemented with an integrated validation circuit 125, the processor 300 may further include a trigger circuit 318 incorporating either or both of a timer 320 and a random number generator 322, and/or non-volatile-memory 324. The functions of the timer 320 and RNG 322 may be the same or similar to that described above. The trigger circuit 318 may be employed to ensure that verification microcode 324 is run on a periodic basis.

When incorporated with the processor 300, the functions of a separate validation circuit 125 may have much better access to the overall system as well as better protected from attack. While techniques exist to mount hardware attacks on highly integrated devices such as processors, such attacks usually require sophisticated equipment and a high degree of skill making these attacks difficult to mount on a broad scale.

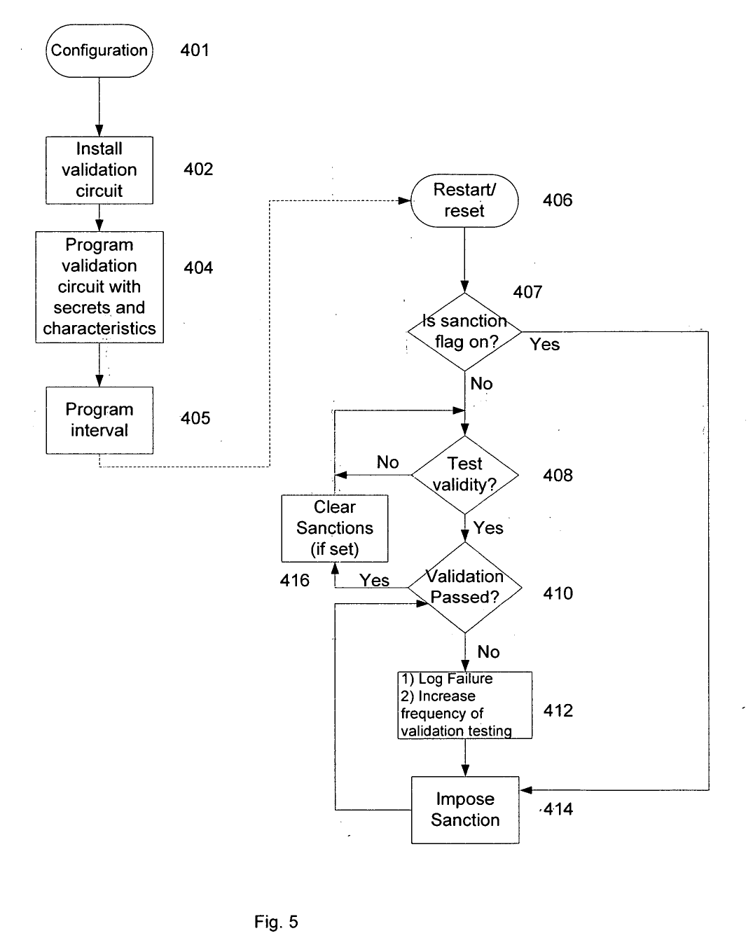

Referring to FIG. 5, a flowchart showing a method for validating the authenticity and/or integrity of computer software, firmware or microcode is discussed and described. During configuration 401, a computer 110 may have a validation circuit 125 installed 402 as part of the initial manufacturing process of either the main computer as a whole or when manufacturing components thereof, such as a processor chip or a circuit board. When the validation circuit 125 uses one or more discrete components, the circuit may be embedded in a circuit board or underneath another component to increase the difficulty of hardware tampering to circumvent or replace the validation circuit 125.

The validation circuit 125 may then be programmed 404 with not only the characteristics that will be tested, but any required cryptographic secrets or data. For example, a root certificate or the public key associated with a trusted Certificate Authority or derived symmetric key may be installed. This may be used to verify the authenticity of various data, e.g. version info of the subject logic (to be validated). Another possible use is to verify a trusted party to allow an update the programming of the validation circuit 125. Additionally, one or more additional asymmetric keys may be programmed for verification of received information, such as updates, using another cryptographic scheme. Cryptographic verification may also be required when clearing sanctions, if not done automatically. In another example, the value of an expected hash may be programmed as well as a memory range for measuring against the expected hash. Yet another aspect that may be programmed in the validation circuit 125 is a sanction or escalating series of sanctions.

When the validation circuit 125 has been programmed 404, an interval for activating the validation circuit 125 may be programmed 405. The interval may be programmed separately from other programming to allow an administrator or service technician to increase the frequency of testing. For example, after restoring the state of a system that failed a previous validation test, the technician may increase the testing frequency from once a year to once a month (reflecting less trust in the system or user). Similarly, the validation circuit 125 may autonomously increase the testing frequency 412 upon various conditions, e.g. a validation test failure. The interval may be based on any of several criteria, or combinations of the criteria. The test may be performed on or after a given calendar date. The test may be performed after a given period of use, such as hours of powered up time. A statistical criteria using a random number as described above may be used.

After the restart, a sanction flag, for example, stored in non-volatile memory 216, may be used to indicate that the computer 110 is currently being sanctioned. The enforcement circuit 210 may re-activate a previous sanction 414, but in some cases the sanction may progress through increasingly drastic measures. In some embodiments, the sanction may be dramatic, crippling the computer 110. The non-volatile memory available may impact how the sanction is carried out, logged, and repaired. For example, the sanction may be responsive to a flag bit set in non-volatile memory 216. When non-volatile memory 216 is not readily available or itself may be subject to tampering, fusible links may be used to indicate a sanctioned state. Replacing the chip containing the fuse may be necessary or alternately, an additional fusible link may be “blown” to indicate the sanction is no longer in place.

When the sanction flag is not active the no branch of block 407 may be followed and the validation circuit 125 may enter a mode of periodic testing 408, corresponding to the interval programmed at 405. The interval may, depending on design choices, correspond to an exact date, a fixed or variable timed interval, or on a random basis given some criteria, as described above.

The interval is checked periodically at 408 and if the interval has not expired, a wait is imposed, the no branch of 408 may be followed and the interval test 408 repeated. When the interval has expired, the yes branch from 408 may be followed. The validation test may be performed at block 410. The validation test 410 may include verifying the digital signature of a pre-determined element, such as a memory range, a program, software code, a software code fragment, firmware, or micro-code. The digital signature may be associated with a peripheral, driver, monitor, operating system, Basic Input Output Structure (BIOS), embedded computer firmware, CPU or computer micro-code. A more comprehensive test may include testing or verifying more than one of these elements. The validation test 410 may also include or involve calculating a hash over a range of memory. The range of memory may also include multiple portions of memory, for example, segments from both random access memory and non-volatile memory. The memory to be tested may include one or more portions of memory specified identified by a digitally signed metadata, provided during manufacturing, or accompanying the update of the subject code/firmware/program to be protected and validated.

The metadata may include an extended certificate providing a chain of certificate hierarchy to an ultimate root certificate authority. When the validation circuit 125 has at least occasional access to the Internet, the validity of the certificate may be checked using a certificate revocation list (CRL). Similarly, when the validation circuit 125 has at least occasional access to the Internet, the version of code to be validated, and hence the version of the validation software data may be confirmed, and if necessary, updated.

When the validation test fails, the no branch from 410 is taken, and an optional failure message may be logged 412. The logged failure message may be used for later analysis or recovery. The interval for retesting may also be set, specifically, the interval may be reduced to determine if the computer has been restored to a compliant state. Even after restoration, the interval may remain shortened.

A sanction may then be imposed 414 to limit the function of the computer 110. The sanction may be severe, such as completely disabling the computer 110, requiring maintenance or repair by a dealer or authorized service technician. Other, less severe, sanctions may also be activated. Other sanctions for limiting the function of the computer may include limiting communication access or limiting the number of messages that can be sent or received, limiting the speed of operation, or limiting the instruction set architecture (ISA) of the processor 300. Other sanctions may include reducing a graphic display resolution or color depth or frequent, periodic resetting of the computer 110.

The validation circuit 125 may be programmed to continue testing after sanctions have been imposed at 414. The loop may proceed from 414 to 410. When the validation test passes, any existing sanctions may be cleared in response to the computer 110 again being in compliance with the requirements of the underwriter. In this example, the validation circuit 125 itself is responsible for clearing the sanctions. In other embodiments, the sanctions may be removed by a service technician or in response to a command from an verified, trusted source.

I claim:

1. A computer configured for self-validation comprising:
a processor;
a memory coupled to the processor; and
a validation circuit coupled to the processor and the memory, the validation circuit operational to validate a characteristic of the computer and further operational to restrict the function of the computer when the validation fails.

2. The computer of claim 1, further comprising a trigger circuit for determining an interval for causing the validation circuit to validate the characteristic of the computer during the interval.

3. The computer of claim 2, wherein the interval is one of statistical, timed, and random.

4. The computer of claim 2, wherein the validation occurs at an increased frequency after the validation fails.

5. The computer of claim 1, wherein the validation circuit comprises a cryptographic capability.

6. The computer of claim 1, wherein the characteristic is one of a digitally signed software code, a hash of a memory range, an expiration of a software code, revocation of a digital signatory, and an expiration date.

7. The computer of claim 1, further comprising an enforcement circuit responsive to the validation circuit for restricting the function of the computer when the validation fails.

8. The computer of claim 1, wherein the processor comprises the validation circuit.

9. A validation circuit in a computer, the validation circuit comprising:
a triggering circuit;
a logic circuit coupled to the triggering circuit; the logic circuit for verifying a characteristic of the computer; and
an enforcement circuit coupled to the verification circuit; wherein the enforcement circuit, in response to a signal from the logic circuit, limits the performance of the computer.

10. The validation circuit of claim 9, further comprising a cryptography circuit wherein the logic circuit verifies the characteristic using the cryptography circuit.

11. The validation circuit of claim 9, wherein the enforcement circuit limits the performance of the computer by one of a periodic reset, a reduction in processor capacity and a reduction in display resolution.

12. The validation circuit of claim 9, wherein the triggering circuit comprises one of a clock and a random number generator.

13. The validation circuit of claim 9, the validation circuit being resistant to tampering from another component of the computer.

14. A method for authenticating a computer comprising:
providing a validation circuit;
programming the validation circuit with information corresponding to a characteristic of the computer;
programming the validation circuit to activate at an interval;
validating the characteristic of the computer; and
limiting a function of the computer when the validating the characteristic of the computer fails.

15. The method of claim 14, further comprising programming the validation circuit with a cryptographic secret.

16. The method of claim 14, wherein the validating further comprises verifying at one of a random interval and a timed interval.

17. The method of claim 14, wherein the validating further comprises one of verifying a digital signature of a code function and verifying a hash of a memory range.

18. The method of claim 14, further comprising logging a failed verification of the characteristic of the computer, and setting a non-volatile flag to be evaluated upon restart/reset of the computer.

19. The method of claim 14, wherein the limiting a function of the computer further comprises limiting a number of communication messages.

20. The method of claim 14, wherein the limiting a function of the computer further comprises one of limiting a speed of operation and limiting operation to a subset of available software executable code.
